(19) United States
(12) Patent Application Publication
(10) Pub. No.: US 2011/0270639 A1
(43) Pub. Date: Nov. 3, 2011

(54) AUTOMATED BUSINESS PROCESS MODEL DISCOVERY

(76) Inventors: Ken Blackwell, Redding, CT (US); Benny Tseng, Brookfield, CT (US)

(21) Appl. No.: 13/179,484

(22) Filed: Jul. 9, 2011

Related U.S. Application Data
(62) Division of application No. 12/262,250, filed on Oct. 31, 2008.

(51) Int. Cl. G06Q 10/00

(52) U.S. Cl. 705/7.11

(57) ABSTRACT

A computer-implemented method includes:
(A) receiving descriptions of a plurality of paths of instances of a transaction through a computer system; and
(B) generating, based on the descriptions, a description of a business process model of the transaction. The description describes the plurality of paths through the computer system.

### CROSS-REFERENCE TO RELATED APPLICATIONS

This application is a divisional of copending U.S. patent application Ser. No. 12/262,250 entitled “Automated Business Process Model Discovery” filed Oct. 31, 2008 and claims the benefit of U.S. Provisional Application No. 60/984,316 filed on Oct. 31, 2007, the contents of which are hereby incorporated by reference in their entirety.

### BACKGROUND

Executing a large information technology (IT) project at an enterprise often involves documenting the existing business processes of the enterprise. This set of existing business processes is known as the “as-is” business process model, in contrast to the “to-be” business process model that results from the IT project. The act of documenting the existing business processes that comprise the “as-is” business process model is often the first and one of the most costly steps in the project.

Documenting the as-is business model can be costly and time-consuming because, for example, the processes in that model may not have been explicitly engineered and may not be under the management of a formal “business process execution engine,” since such engines are a relatively recent development. As a result, attempts to document the “as-is” model often take place over a substantial period of time as systems analysts attempt to document it by manually observing and analyzing existing business processes. For example, such analysts typically attempt to identify existing processes by interviewing personnel who are familiar with those processes. One problem with an interview-based approach is that its results may be skewed by the subjective judgments and limited knowledge of those interviewed. Furthermore, documenting the as-is business model using interviews is labor-intensive and therefore costly.

The problem of documenting the as-is business model in this and other conventional ways is further compounded by the fact that the as-is business model may change as attempts are made to document it over the course of weeks or months. As a result, those who are writing the documentation of the as-is business model must often change that documentation as they are writing it so that it reflects recent changes to the model itself. Such efforts to capture a moving target typically introduce further delay and opportunities for error into the business process model documentation process.

### SUMMARY

In one embodiment of the present invention, a computer-implemented method comprises: (A) receiving descriptions of a plurality of paths of instances of a transaction through a computer system; (B) generating, based on the descriptions, a description of a business process model of the transaction, the description describing the plurality of paths.

The description may be generated by, for example: (B)(1) identifying frequencies of paths in the plurality of paths; and (B)(2) including, in the business process model description, a description of the frequencies of the paths. The business process model description may be written in a business process modeling language, such as the Business Process Execution Language (BPEL). The business process model description may describe the plurality of paths as a directed graph representing a union of the plurality of paths.

Other features and advantages of various aspects and embodiments of the present invention will become apparent from the following description and from the claims.

### BRIEF DESCRIPTION OF THE DRAWINGS

FIG. 1 is a dataflow diagram of a system for generating a description of an as-is business process model according to one embodiment of the present invention;

FIG. 2 is a flowchart of a method that is performed by the system of FIG. 1 according to one embodiment of the present invention; and

FIG. 3 is an illustration of a directed graph of unique transaction instances observed in a business system according to one embodiment of the present invention.

### DETAILED DESCRIPTION

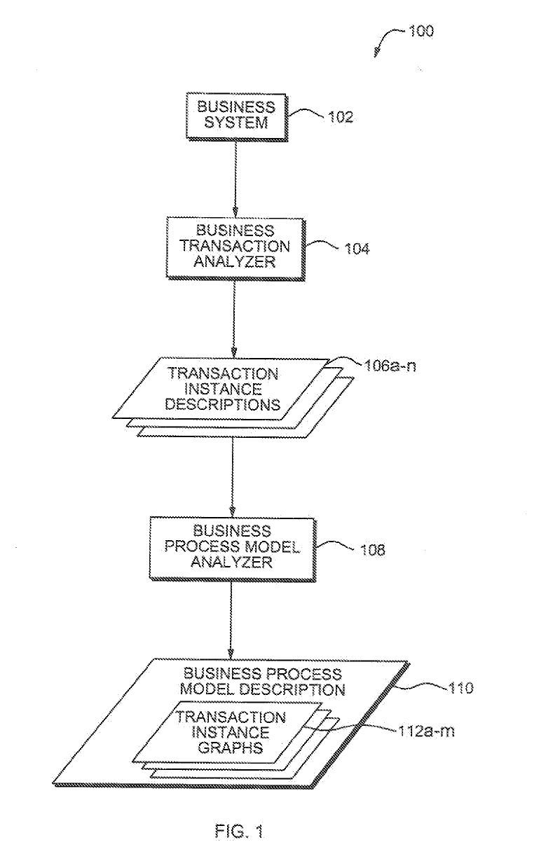

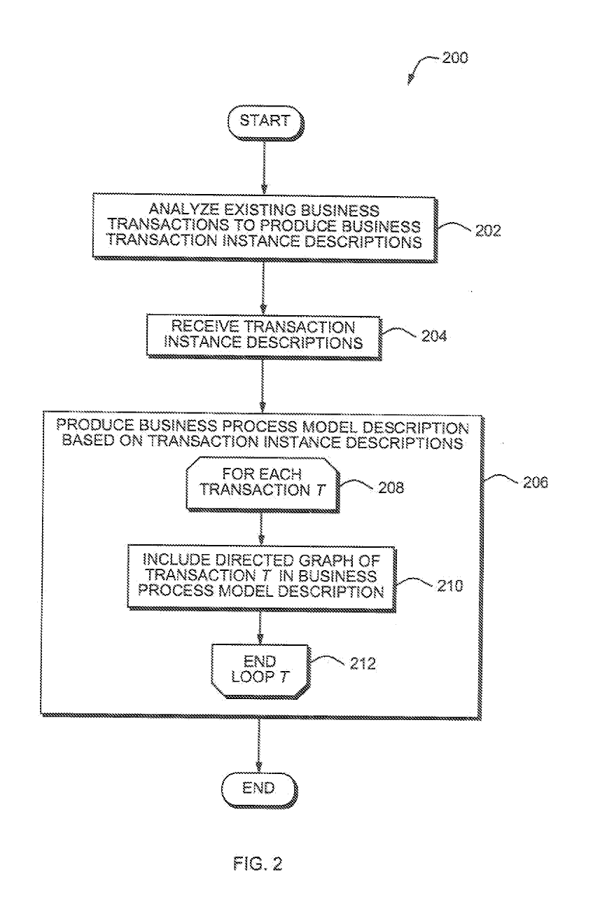

Referring to FIG. 1, a dataflow diagram is shown of a system 100 for generating a description of an as-is business model 110 of existing processes in a business system 102 according to one embodiment of the present invention. Referring to FIG. 2, a flowchart is shown of a method 200 performed by the system 100 of FIG. 1 according to one embodiment of the present invention.

The business system 102 of FIG. 1 may be any system, sub-system, or combination of systems in a business. For example, the business system 102 may include a network of computer systems running software applications. Although the term “business system” is used herein, the techniques disclosed herein may be applied to systems used in organizations other than businesses, such as universities or nonprofit organizations. The business system 102 of FIG. 1 is illustrated as a black box because embodiments of the present invention are not limited to use with business systems of any particular type.

A business transaction analyzer 104 analyzes existing business transactions in the business system 102 to produce business transaction instance descriptions 106a-n describing those existing business transactions (step 202). The business transaction analyzer 104 may, for example, be implemented using the techniques disclosed in commonly-owned U.S. Pat. No. 7,003,781 B1, entitled, “Method and Apparatus for Correlation of Events in a Distributed Multi-System Computing Environment.” For example, the business transaction analyzer 104 may use such techniques to observe and identify a collection of “events” which are logically correlated with each other. Such a collection of events may form, or represent part of, a single business transaction. A sequence of such events within a single business transaction may follow what is referred to herein as a “transaction path.”

Consider an example in which the business system 102 processes three mortgage applications. When the business system 102 processes the first mortgage application, the business system 102 may process events A₁, B₁, and C₁. When the business system 102 processes the second mortgage application, the business system may process events A₂, B₂, A₂, and D₁. (The differing subscripts in events A₁ and A₂, for example, indicate that these are different instances of the same type of event, whereas events A₁ and B₁ are different types of events.) When the business system 102 processes the third mortgage application, the business system 102 may process events A₃, B₃, and E₁.

The business transaction analyzer 104 may observe all of these events as they pass through the system 102 and correctly identify that events A₁, B₁, and C₁ are logically correlated with each other, i.e., that they form part of a single business transaction instance, even if those events do not occur sequentially within the system 102. For example, the events mentioned above may actually occur in the sequence A₁, A₂, B₁, A₃, B₃, A₂, C₁, B₂, D₁, E₁. Furthermore, events from additional transaction instances (not shown) may be interspersed with these events.

Once the business transaction analyzer 104 identifies events that are logically correlated with each other as part of different transaction instances, the analyzer 104 may produce descriptions 106a-n of those transaction instances, where n is the number of descriptions. The transaction instance descriptions 106a-n may, for example, include identifiers of events within each transaction instance. For example, transaction instance description 106a may include identifiers of the events A₁, B₁, and C₁ within the first transaction instance described above, transaction description 106b may include identifiers of the events A₂, B₂, A₂, and D₁ within the second transaction instance described above, and transaction description 106c may include identifiers of events A₃, B₃, and E₁ within the third transaction instance described above. As described in more detail in the above-referenced patent, the transaction descriptions 106a-n may include additional information, such as the times at which their constituent events occurred.

In summary, the business transaction analyzer 104 may track transaction instances as they flow through the system 102 and produce output describing those transaction instances. Although the business transaction analyzer 104 may perform this analysis using the techniques disclosed in the above referenced U.S. Pat. No. 7,003,781 B1, this is not a limitation of the present invention. Rather, the business transaction analyzer 104 may use other techniques to produce the transaction instance descriptions 106a-n.

Note that although the term “transaction” is sometimes used to refer to a series of actions within a single application which are performed as an “atomic” unit of work (such as a database “transaction”), the term “transaction” as used herein is not limited to this technical meaning. Rather, the term “transaction” as used herein includes its more common meaning in business, which refers to a unique business interaction, such as a stock trade or an online purchase. Business transactions may be complex events made up of a series of interrelated activities (simple events) that, when executed, form the transaction. In enterprise environments, business transactions frequently are distributed, requiring numerous related units of work, which are tied together with transactional middleware such as WebSphere MQ. Therefore, a “transaction” as that term is used herein may include one or more “events.” An “event” may, however, be or include an atomic “transaction” as that term is understood in its narrower technical sense.

The business transaction analyzer 104 may analyze and produce descriptions of some or all of the transaction instances observed in the business system 102. For example, the business transaction analyzer 104 may attempt to identify and produce a description of every transaction instance observed in the system 102. Alternatively, for example, the business transaction analyzer 104 may attempt to identify and produce a description only of instances of a certain transaction (such as a mortgage application processing transaction) in the system 102.

The business transaction analyzer 104 may observe two or more instances of the same transaction. For example, the business transaction analyzer 104 may observe a first instance of a transaction instance including events A₁, B₁, and C₁, and a second transaction instance of the same transaction including events A₂, B₂, and C₂. In such a case, the business transaction analyzer 104 may produce two transaction instance descriptions, one for each observed instance of the transaction. The business transaction analyzer 104 need not group together or otherwise summarize multiple instances of the same transaction, or transaction instances which are similar to each other in other ways.

A business model analyzer 108 receives as input the transaction instance descriptions 106a-n produced by the business transaction analyzer 104 (step 204), and produces a business model description 110 based on the transaction instance descriptions 106a-n (step 206). The business process model analyzer 108 may produce the business process model description 110 in any of a variety of ways, and the business process model description 110 may take any of a variety of forms. For example, the business process model analyzer 108 may include all of the transaction instance descriptions 106a-n in the business process model description 110. As another example, the business process model analyzer 108 may include in the business process model description 110, for each observed transaction, a directed graph of paths observed to be taken by instances of that transaction (FIG. 2, steps 208-212, resulting in transaction instance graphs 112a-m).

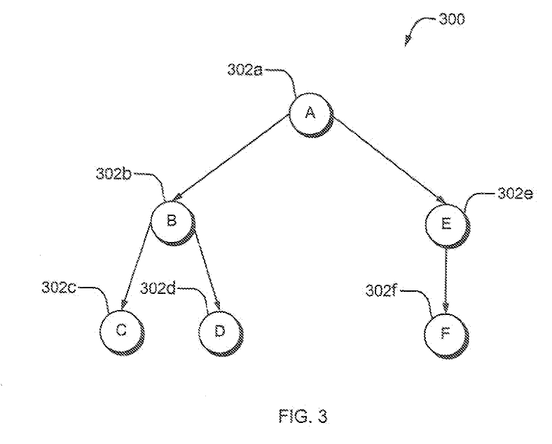

For example, assume that the following instances of a particular transaction have been observed: (1) A₁, B₁, C₁; (2) A₁, B₁, C₂; (3) A₃, B₃, D₁; and (4) A₄, E₁, F₁. A directed graph 300 of the unique paths represented by these transaction instances is shown in FIG. 3. A first path in the graph 300 includes nodes 302a, 302b, and 302c, corresponding to the transaction instance path A, B, C. A second path in the graph 300 includes nodes 302a, 302b, and 302d, corresponding to the transaction instance path A, B, D. A third path in the graph 300 includes nodes 302a, 302c, and 302f, corresponding to the transaction instance path A, E, F. Note that although four transaction instances were observed, the graph 300 represents only three transaction instance paths, since one transaction instance path (paths (1) and (2) above) was observed in two instances.

The graph 300 may be one of the graphs 112a-m in the business process model description 110. Although the business process model description 110 may include only a single graph representing observed paths of a single transaction, the business process model description 110 may include graphs representing observed paths of multiple transactions.

The business process model analyzer 108 need not analyze or use all of the transaction instance descriptions 106a-n to produce the business process model description 110. For example, the business process model analyzer 108 may sample only a subset (e.g., 1 out of 100) of the transaction instances described by the transaction instance descriptions 106a-n. In such a case, the resulting business process model description 110 would reflect only a subset of the observed transaction instances. If the number of observed transaction instances is large and varied enough, however, then using even a small subset of those transaction instances may include all possible transaction paths.

The business process model description 110 may include additional information about the observed transaction instances. For example, the business process model description 110 may include information about the observed frequencies of different transaction paths. Consider again the example provided above, in which four transaction instances were observed, representing three unique paths, the first of which was observed twice, the second of which was observed once, and the third of which was observed once. This information about the observed frequencies of each path may be stored in the business process model description 110 and associated with the paths. For example, the business process model description 110 may indicate that the first path has a frequency of 50%, the second path has a frequency of 25%, and the third path has a frequency of 25%.

Note that the graphs 112a-m may be represented in the business model description 110 in any format. For example, the graphs 112a-m may simply be represented by a list of the unique paths taken by instances of the transaction. The business process model description 110 may be represented in a document written in a business process modeling language such as Business Process Execution Language (BPEL). The business process model description 110 may then be imported into a business process modeling tool (such as HP Business Process Insight or IBM Websphere Business Process Modeler) for further analysis (step 208).

Among the advantages of the invention are one or more of the following. Embodiments of the invention greatly reduce the time, labor, and cost required to document the “as-is” business process model of existing complex IT application environments, by producing a description of that business process model automatically based on observations of actual transaction instances. Previously such business process model descriptions were generated manually, which was a tedious and time-consuming process. Reducing the time and effort required to produce the “as-is” business process model enables any task which relies on such a model, such as business process re-engineering, to be initiated and completed more quickly and at lower cost.

A related benefit of embodiments of the present invention is that they may be used to produce business process model descriptions in a format, such as BPEL, which may be imported directly into a business process modeling tool, such as HP Business Process Insight, where the model may be manipulated and enriched. The ability to import such business process models directly into such tools eliminates the need for human intervention between the step of creating the business process model description and the step of analyzing the business model, thereby further contributing to the efficiency of the overall task of business process analysis and/or re-engineering.

Another benefit of embodiments of the present invention is that they may be used to build a business process model objectively, in contrast to conventional techniques which rely on the subjective input of human interviewees and others. For example, embodiments of the present invention may build an as-is business process model based solely on data collected from a running system, without relying on the memory or interpretation of people, thereby resulting in an objective and therefore more accurate as-is business process model.

One benefit of such objective business process models is that they may reflect actual probabilities of different transaction paths being followed. One benefit of obtaining such information about the probabilities associated with different transaction paths is that such information may be helpful in running simulations of business processes based on the business process model. Such simulations may be helpful, for example, to identify bottlenecks in the business process. Such bottlenecks may be identified more accurately if accurate information is available about the throughput and volume along each transaction path. Such information enables the analyst to answer “what-if” type questions, such as, “How would doubling the processor speed of the node running application X affect the performance of business process Y?” Basing such information on actual observed data enables questions such as this to be answered more accurately, making the answers more useful.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Certain references may be made herein to Business Process Execution Language (BPEL), which is a business process modeling language that is executable. BPEL, however, is merely one example of a business process modeling language. Embodiments of the present invention are not limited to use with BPEL, however, and may be used with other business process modeling languages.

Certain references may be made herein to certain business process visibility software packages, such as HP OpenView Business Process Insight and IBM Websphere Business Process Modeler. Such software delivers business process health, performance, and impact information. For example, such software packages provide visibility into the health and performance of the business processes that are running over an enterprise's IT infrastructure so that such information may be used to assess the financial and business impact of delays or blockages in a process due to an IT performance problem or other incident, such as an IT outage. The particular software packages mentioned herein, however, are provided herein merely as examples, not as limitations of the present invention, which may be used in conjunction with other kinds of software and systems for providing visibility into business processes.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
using a computer, identifying logical correlations among events by analyzing event descriptions of those events, said events occurring in the course of executing transactions in a network of computer systems;
using said computer and based on said logical correlations, producing transaction-path-instance descriptions for transaction- path instances, each transaction-path instance including a collection of said events that are logically correlated with each other; and
using said computer and based on said transaction-path- instance descriptions, producing a business model including plural transaction paths of which said transaction-path instances are instances.

2. A method as recited in claim 1 wherein said business model associates with each of said transaction paths a value corresponding to a number of corresponding transaction-path instances associated with that transaction path.

3. A method as recited in claim 1 wherein said business model is expressed in a business-process-modeling language.

4. A method as recited in claim 1 wherein said business model includes a directed graph corresponding to a union of transaction paths taken by said transaction-path instances.

5. A system comprising non-transitory tangible computer-readable storage media encoded with code defining:
a business transaction analyzer configured to, when executed by a processor,
analyze event descriptions of events that occurred in a computer network to identify logical correlations among said events, and
based on the identified logical correlations, produce transaction-path-instance descriptions for transaction-path instances, each transaction-path instance including a collection of said events that are logically correlated with each other; and
a business process model analyzer configured to, when executed by said processor, using said transaction-path instance descriptions, produce a business model including plural transaction paths of which said transaction-path instances are instances.

6. A system as recited in claim 5 further comprising said processor.

7. A system as recited in claim 5 wherein said business model indicates the relative numbers of transaction-path instances respectively associated with said transaction paths.

8. A system as recited in claim 5 wherein said business model is expressed in a business-process-modeling language.

9. A system as recited in claim 5 wherein said business model is expressed as a directed graph corresponding to a union of said transaction paths.
